(19) United States
(12) Patent Application Publication
(10) Pub. No.: US 2025/0252221 A1
(43) Pub. Date: Aug. 7, 2025

(54) POLICY-DRIVEN KERNEL EXTENSION SECURITY

(71) Applicant: International Business Machines Corporation, Armonk, NY (US)

(72) Inventors: Avery Blanchard, Raleigh, NC (US); Gheorghe Almasi, Ardsley, NY (US); Hubertus Franke, Cortlandt Manor, NY (US)

(21) Appl. No.: 18/434,628

(22) Filed: Feb. 6, 2024

(51) Int. Cl. G06F 21/62; G06F 9/54

(52) U.S. Cl. CPC G06F 21/629; G06F 9/545

(57) ABSTRACT

A computer-implemented method (CIM), according to one embodiment, includes receiving, at a kernel space of a data processing system, from a user space, a policy, a kernel extension code, and metadata associated with the kernel extension code. The metadata describes at least one type of attachment point in the kernel space, and the policy includes an allowlist and a blocklist of metadata for the attachment points. The method further includes validating the metadata against the policy, and performing an integrity measurement on the kernel extension code. In response to a determination that the metadata is validated against the policy and the integrity measurement is verified, the kernel extension code is loaded in the kernel space.

### BACKGROUND

The present invention relates to cloud and server systems, and more specifically, this invention relates to loadable kernel extensions.

Cloud computing is the availability of computer system resources. These resources typically include data storage on cloud storage and computing resources, which may be distributed across a plurality of locations. Operating systems extend their functionality through loadable driver and/or filesystems, as well as observations and/or debugging tools, which all become privileged codes executing in a kernel. A kernel is a computer program of a computer's operating system that controls all aspects of the operating system. Examples of the filesystems and tools mentioned above include, e.g., kernel modules (such as filesystems, device drivers, etc.), eBPF (observability, code path reduction on network, storage), and kprobes (debugging and observability). In order to maintain the relatively high security standards defined by a kernel, these extensions are implicitly trusted.

### SUMMARY

A computer-implemented method (CIM), according to one embodiment, includes receiving, at a kernel space of a data processing system, from a user space, a policy, a kernel extension code, and metadata associated with the kernel extension code. The metadata describes at least one type of attachment point in the kernel space, and the policy includes an allowlist and a blocklist of metadata for the attachment points. The method further includes validating the metadata against the policy, and performing an integrity measurement on the kernel extension code. In response to a determination that the metadata is validated against the policy and the integrity measurement is verified, the kernel extension code is loaded in the kernel space.

A computer program product (CPP), according to another embodiment, includes a set of one or more computer-readable storage media, and program instructions, collectively stored in the set of one or more storage media, for causing a processor set to perform the foregoing method.

A computer system (CS), according to another embodiment, includes a processor set, a set of one or more computer-readable storage media, and program instructions, collectively stored in the set of one or more storage media, for causing the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a flowchart of a method, in accordance with one embodiment of the present invention.

FIG. 4 is a flowchart of a method, in accordance with one embodiment of the present invention.

FIG. 5 is a system policy, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for policy-driven kernel extension security.

In one general embodiment, a CIM includes receiving, at a kernel space of a data processing system, from a user space, a policy, a kernel extension code, and metadata associated with the kernel extension code. The metadata describes at least one type of attachment point in the kernel space, and the policy includes an allowlist and a blocklist of metadata for the attachment points. The method further includes validating the metadata against the policy, and performing an integrity measurement on the kernel extension code. In response to a determination that the metadata is validated against the policy and the integrity measurement is verified, the kernel extension code is loaded in the kernel space.

In another general embodiment, a CPP includes a set of one or more computer-readable storage media, and program instructions, collectively stored in the set of one or more storage media, for causing a processor set to perform the foregoing method.

In another general embodiment, a CS includes a processor set, a set of one or more computer-readable storage media, and program instructions, collectively stored in the set of one or more storage media, for causing the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as kernel extension security code of block 150 policy-driven kernel extension security. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

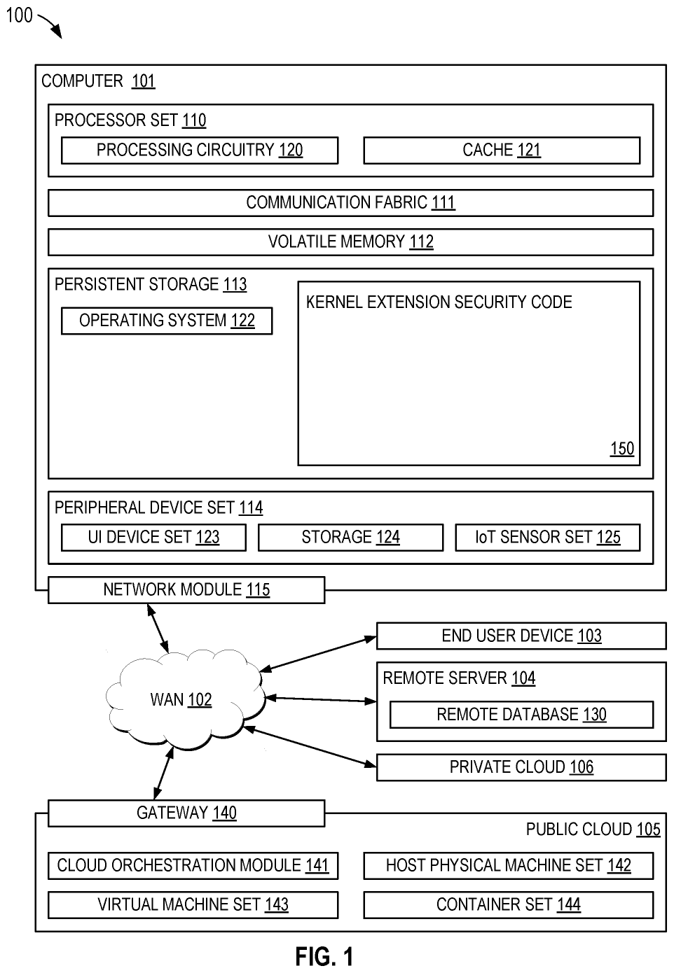

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, cloud computing is the availability of computer system resources. These resources typically include data storage on cloud storage and computing resources, which may be distributed across a plurality of locations. Operating systems extend their functionality through loadable driver and/or filesystems, as well as observations and/or debugging tools, which all become privileged codes executing in a kernel. A kernel is a computer program of a computer's operating system that controls all aspects of the operating system. Examples of the filesystems and tools mentioned above include, e.g., kernel modules (such as filesystems, device drivers, etc.), eBPF (observability, code path reduction on network, storage), and kprobes (debugging and observability).

In order to maintain the relatively high security standards defined by a kernel, these extensions are implicitly trusted. However, this conventional implicit trust of kernels creates potential vulnerabilities within data processing systems. For example, an operating system has only limited protections for the privileged execution of untrusted software. Furthermore, loadable kernel extensions are exempt from some native security mechanisms of operating systems. Once loaded, the extensions have full privilege into the kernel address space as defined by the framework. For example, the kernel modules are compiled in the context of the kernel and are granted full addressability, e.g., read and/or write access. In another example, eBPF have access to exposed ebpf_access_functions( ) to kernel data structures. Implementing access privileges is problematic because of the relatively vast visibility/access to kernel data and processes, as well as the transitive exposure that exists due to ability to interoperate with other kernel extensions. Furthermore, there is a complexity associated with access privileges in that existing eBPF kernel verifiers have grown relatively substantially over time. Such complexity inevitably leads to verifier bugs and vulnerabilities. For example, over the course of two years, at least 22 verifier CVEs (Code Vulnerabilities and Exposures) have been known to have been reported.

Uncontrolled and unlimited observability and access to kernel data is typically undesirable in production systems. These programs present a gap in security, integrity, and trust. Accordingly, there is a longstanding need for a relatively finer grain, none-persistent technique to first verify and then permit extensions selected access within data processing systems based on policies that system administrators set.

In sharp contrast to the deficiencies of the conventional techniques described above, and in order to mitigate vulnerabilities within data processing systems that exist based on the conventional implicit trust of kernels, the techniques of embodiment and approaches described herein incorporate at least five features that are needed to achieve relatively higher security with kernel extensions. A first of these features is policy enforcement and offers an ability to restrict kernel extension to specific type of attachments (kernel, LSM), attachment locations and required load points. A second of these features includes integrity measurement which involves the collection, storage and measurement of program information via rooted and trusted hardware. Third, permissions checks can restrict the ability to load extension based on user privileges. Fourth, signature verification may be used to ensure that extension signatures are properly verified by the kernel. Fifth and last, kernel access limitations can ensure that only architected and verified interfaces have access to the kernel data (even after the extension having been accepted into the kernel address space). These techniques offer a framework and extensible interface for permission checks, policy enforcement, signature verification, integrity measurements and kernel access limitations for loadable kernel extensions. These techniques furthermore offer policy-based restrictions starting at load-time and throughout run-time including life cycle management such as revocation.

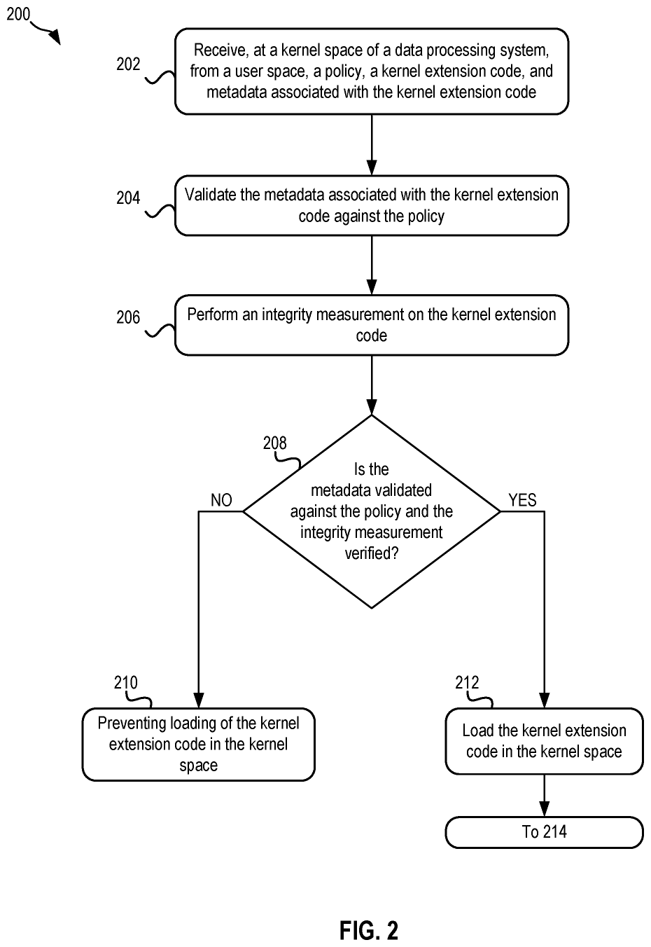

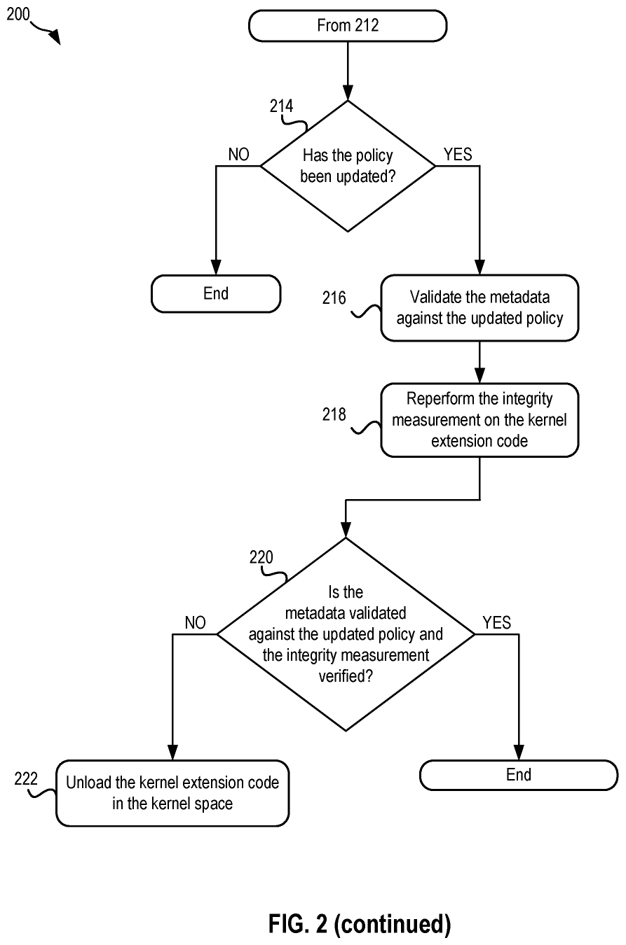

Now referring to FIG. 2, a flowchart of a method 200 is shown according to one embodiment. The method 200 may be performed in accordance with the present invention in any of the environments depicted in FIGS. 1-5, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that the techniques of method 200 relate to the field of cloud and server systems and in particular the security assessment and control of loadable kernel extensions such as modules and eBPF programs. Accordingly, one or more of the operations of method 200 may be performed in and/or with respect to a kernel space of a data processing system of a type that would become apparent to one of ordinary skill in the art after reading the descriptions herein. Furthermore, one or more operations described below mention a user space, that may interact with the kernel space, e.g., receive contents from. The user space may be an application running at a relatively lower privilege. Communication may typically occur from user (application) to kernel is via so called system calls.

Operation 202 includes receiving, at a kernel space of a data processing system, from a user space, a policy, a kernel extension code, and metadata associated with the kernel extension code. In some approaches the received policy, the kernel extension code, and/or the metadata may be received independently, e.g., such as over time and/or from a plurality of sources, while in some other approaches, they may be received together, e.g., in a packet.

In some preferred approaches, the metadata describes at least one type of attachment point in the kernel space. The type of attachment point may depend on the approach and may include one or more of type that would become apparent to one of ordinary skill in the art after reading the descriptions herein. In one specific example that is based on eBPF, there may be various potential attachment points. It may be noted that eBPF is event driven and may be executed when a function is called in the kernel. Accordingly, an attachment point for an eBPF program is the function that is invoked. More specifically, the attachment point may be based on the packet arrival.

Furthermore, the policy may, in some approaches, include an allowlist and a blocklist of metadata for respective types of the attachment points. In some approaches, one or more of the lists contain names, e.g., saved names, index names, etc., of the type of metadata that are to be allowed or blocked. In some other approaches, the lists contain portions of the types of metadata that are to be allowed or blocked. In yet some other approaches, the list elements are storage locations of the types of metadata that are to be allowed or blocked. The blocklist may additionally and/or alternatively include entries, in some approaches. In one or more of such approaches, the entries of the blocklist may detail restricted metadata attributes which, depending on the approach, may include, e.g., a kernel location, an attach function, a security identity (ID), etc.

The metadata associated with the kernel extension code may, in some approaches, include a plurality of different types of metadata. In some other approaches, the metadata associated with the kernel extension code includes only a single type of metadata. The metadata associated with the kernel extension code may, in some approaches, include an indication of an attachment type, e.g., a plurality of types describing how the program attaches. In some other approaches, the metadata associated with the kernel extension code may additionally and/or alternatively include an indication of a program type, e.g., LSM, system call, etc. In yet another approach, the metadata associated with the kernel extension code may additionally and/or alternatively include program instructions, e.g., in eBPF said program instructions may be provided in a specific ISA (instruction set architecture), which will be executed in a sandbox. Other types of metadata, that the metadata associated with the kernel extension code may include, may be of a type that would become apparent to one of ordinary skill in the art after reading the descriptions herein.

Operation 204 includes validating the metadata associated with the kernel extension code against the policy. Such a validation is, in some preferred approaches, performed in order to ensure that the metadata adheres to the policy. For context, this validation may be performed in order to ensure that the kernel extension code is not fraudulent. In other words, an attempt may be made by unauthorized users and/or devices to slip fraudulent code into the kernel space by sending metadata to a processing circuit performing method 200, where the fraudulent metadata may be disguised as metadata that is from an authorized and/or another trusted device. Metadata validation failure leads to the metadata being flagged. Based on this flagging, any kernel extension code associated with the flagged metadata is prohibited from entering the kernel space, and the kernel space is not compromised. Techniques for performing such a validation of the metadata is described below.

In some approaches in which the metadata associated with the kernel extension code includes a plurality of different types of metadata, validating the metadata against the policy includes iteratively verifying each of the types of metadata against the policy. A determination that the metadata is validated against the policy is made in response to a determination that each of the types of metadata are valid in view of the policy. For example, one or more types of the metadata may be validated against the policy in response to a determination that the types of metadata are included in the allowlist (the metadata matches an entry of the blocklist of metadata) and/or not included in the blocklist of metadata. In contrast, one or more types of the metadata may not be validated against the policy in response to a determination that the types of metadata are not included in the allowlist and/or are included in the blocklist of metadata.

Operation 206 includes performing an integrity measurement on the kernel extension code. For context, the integrity measurement performed on a kernel extension code is a collection, storage and measurement of program information via rooted and trusted hardware. Such measurements are performed in order to verify the verification of programs loaded into the kernel from within a trusted operating system, in some approaches. Performing the integrity measurement, in some approaches, includes performing a measured boot. The integrity measurement may, in some approaches, be performed by executing a cryptographic hash of program instructions. The measurements may, in some approaches, be extended to trusted hardware within the data processing system. In some approaches in which the integrity measurements are stored, the integrity information may be stored in a system log.

Decision 208 includes determining whether the metadata is validated against the policy and whether the integrity measurement is verified. In some preferred approaches, loading of the kernel extension code in the kernel space is dependent on the validation and the verification being successfully performed. For example, in response to a determination that the metadata is not validated against the policy and/or the integrity measurement is not verified, e.g., as illustrated by the “NO” logical path of decision 208, loading of the kernel extension code in the kernel space is prevented, e.g., see operation 210. Furthermore, in some approaches, method 200 includes optionally outputting a notification that details that the kernel extension code is potentially untrustworthy in response to the determination that the metadata is not validated against the policy and/or the integrity measurement is not verified. Such a notification may be output to, e.g., a user device associated with an administrator of the data processing system, user(s) devices associated with users that store data in the data processing system, etc.

In contrast to some approaches described above, in some other approaches a determination may be made that the metadata is validated against the policy and the integrity measurement is verified, e.g., as illustrated by the “YES” logical path of decision 208. In response to the determination that the metadata is validated against the policy and the integrity measurement is verified, the kernel extension code is loaded in the kernel space, e.g., see operation 212.

It should be noted, that in various approaches described herein, the determination of whether or not to load the kernel extension code in the kernel space is based on a determination of whether the metadata is validated against the policy and the integrity measurement is verified. However, in some approaches, the determination of whether or not to load the kernel extension code in the kernel space may additionally and/or alternatively be based on a determination of whether a signature has been verified. For example, in some approaches, method 200 may include performing a verification of a signature included in the kernel extension code. In one or more of such approaches, in response to a determination that the signature is verified, the kernel extension code is loaded in the kernel space. Furthermore, in some approaches, one or more portions of the determination of whether or not to load the kernel extension code in the kernel space may be conditional on the passage of at least some verifications being made. For example, in some approaches, in response to a determination that the signature verification passes, the integrity measurement is performed.

Although, in some approaches, the kernel extension code may be loaded or not loaded in the kernel space based on a determination that one or more validations and/or verifications have been performed, the policy may thereafter be updated, and as a result, impact such a previous conclusion. Accordingly, monitoring may be performed for determining whether a policy has been updated, e.g., see decision 214. In some approaches, the update of the policy may be caused by one or more types of triggers. Various predetermined types of triggers include, e.g., an occurrence of debugging, initiation of a boot phase, etc.

In response to a determination that the policy has been updated, e.g., as illustrated by the “NO” logical path of decision 214, the method 200 optionally end, while in some other approaches, monitoring for such an update ongoingly continues. In contrast, in response to a determination that the policy has been updated, e.g., as illustrated by the “YES” logical path of decision 214, the metadata is validated against the updated policy, and the integrity measurement is reperformed on the kernel extension code, e.g., see operation 216 and operation 218. Results of the metadata being validated against the updated policy and/or the integrity measurement being reperformed on the kernel extension code may be evaluated to determine whether the metadata is validated against the updated policy and the integrity measurement is verified (whether the kernel extension code can remain loaded in the kernel space), e.g., see decision 220.

In response to the determination that the metadata is not validated against the updated policy and/or the integrity measurement is not verified subsequent to the policy being updated, e.g., as illustrated by the “NO” logical path of decision 220, the kernel extension code in the kernel space is unloaded, e.g., see operation 222. In contrast, in response to a determination that the metadata is validated against the updated policy and the integrity measurement is verified subsequent to the policy being updated, e.g., as illustrated by the “YES” logical path of decision 220, the kernel extension code may remain loaded in the kernel space, and method 200 optionally ends, e.g., see “End”.

Various benefits are enabled by deploying the techniques described herein in one or more data processing systems. For example, these techniques enable relatively tighter security state-based policies. Furthermore, these techniques enable relatively finer grain policy based control and thereby enable services to clients. Yet furthermore, by performing the verification and validation operations described herein, troubleshooting and recovery operations that would otherwise be performed in the event that fraudulent metadata and/or fraudulent kernel extension code were able to gain access to the kernel space (as a result of being loaded in the kernel space) are avoided. This improves performance of computer devices within data processing systems because latency is decreased while security and an integrity of the data processing systems are increased. This security is enabled by verifying that kernel extension code will not compromise the kernel space. In order to ensure this, the kernel extension code is first loaded and verified, e.g., measured, within a trusted boundary, e.g., outside of the kernel space.

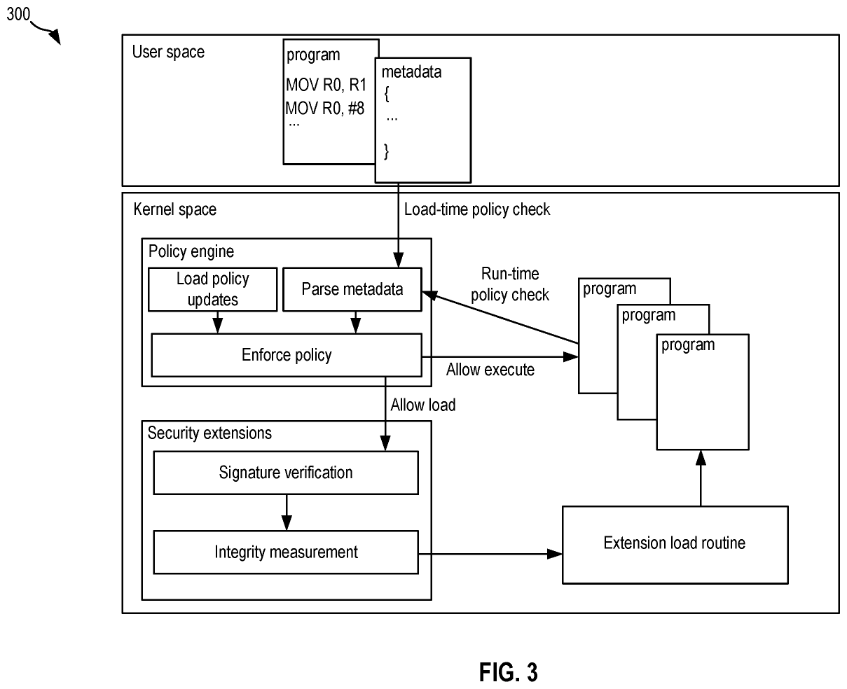

Now referring to FIG. 3, a flowchart of a method 300 is shown according to one embodiment. The method 300 may be performed in accordance with the present invention in any of the environments depicted in FIGS. 1-5, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Method 300 illustrates the loading of a kernel extension, e.g. eBPF, with code and associated metadata.

Method 300 includes a plurality of operations that may be performed in response to a determination that a kernel extension load has occurred and/or a request to perform such a load is received from a user space. For example, one of these operations includes an extension to a policy engine being submitted, e.g., see program and metadata of the user space. A policy, e.g., see load-time policy check, may be loaded in a policy engine of a kernel space to determine whether to load the code in the kernel space. A policy engine may be caused to examine the metadata and compare the metadata to a policy based on the type of attachment, e.g., see parse metadata and enforce policy in the policy engine.

In response to a determination that the policy engine denies access, the load fails, e.g., the load is not allowed to occur. In contrast, in response to a determination that the policy passes, e.g., validations and/or verifications are successful, the extension is submitted for optional signature verification, e.g., see allow load logical path continue to signature verification of a security extensions. In response to a determination that the verification passes, the file is measured (note the program is not yet attached to callbacks in the kernel). In some approaches, the process of method 300 optionally waits for measurements to be verified. In response to a determination that the integrity measurement is passed, the kernel extension code is passed to an extension load routine which may be configured to connects the program, e.g., the kernel extension code, to attachment points in the kernel, e.g., see program.

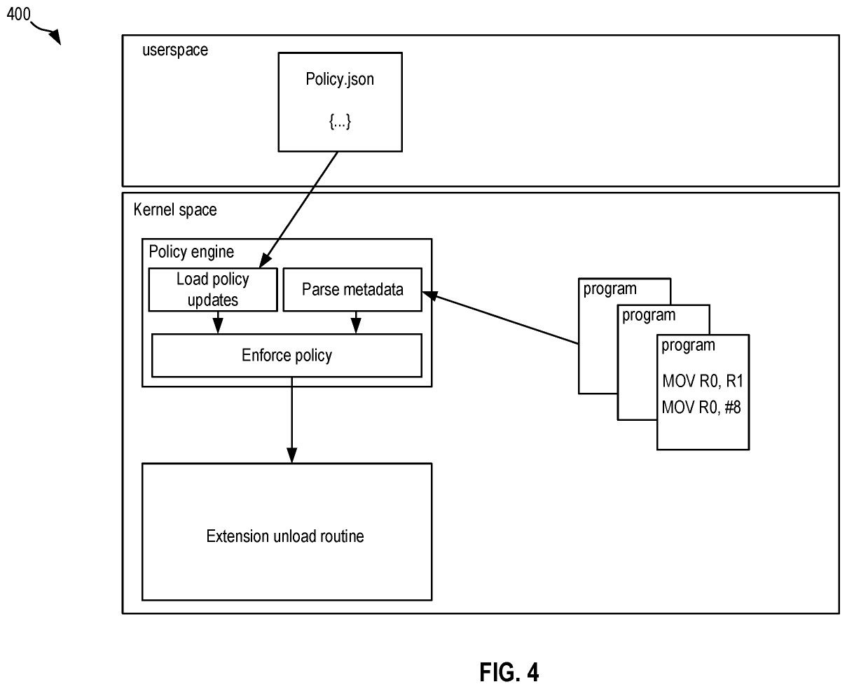

Now referring to FIG. 4, a flowchart of a method 400 is shown according to one embodiment. The method 400 may be performed in accordance with the present invention in any of the environments depicted in FIGS. 1-5, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

Method 400 illustrates a lifecycle management for dynamic policy updates. In response to a determination that a policy update event has occurred, e.g., see updated Policy.json received at a kernel space from a user space, an examination may be performed, e.g., see enforce policy, to ensure that each loaded extension is still valid, e.g., valid in view of the updated policy to ensure continued validity. Policy updates may be loaded within a policy engine and extension program data and metadata may be available in the kernel for performing this examination. In response to a determination that the extension does not conform with the updated policy, an extension unloading is initiated, e.g., see extension unload routine. In some approaches, policy updates are triggered by system phase, e.g., debugging, boot phase, etc.

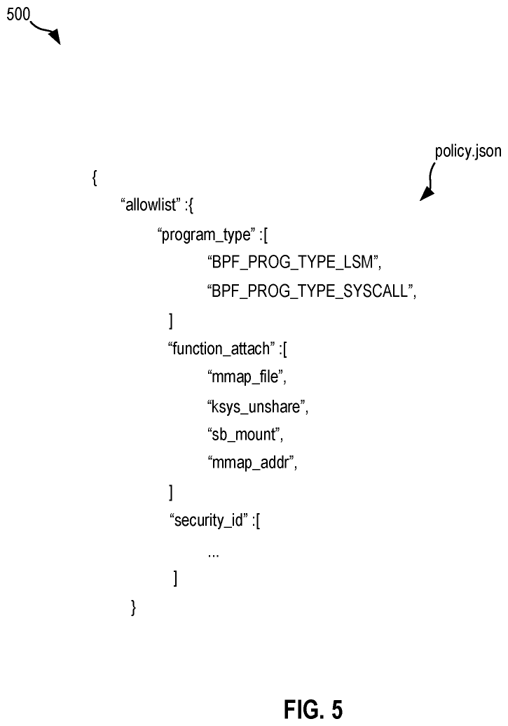

FIG. 5 depicts a system policy 500, in accordance with one embodiment. As an option, the present system policy 500 may be implemented in conjunction with features from any other embodiment listed herein, such as those described with reference to the other FIGS. Of course, however, such system policy 500 and others presented herein may be used in various applications and/or in permutations which may or may not be specifically described in the illustrative embodiments listed herein. Further, the system policy 500 presented herein may be used in any desired environment.

The system policy, e.g., policy.json, like some other policies described herein, may be built from an allowlist and/or blocklist of program metadata. Application of such a policy may be used to perform some rejections based off restricted metadata, e.g., kernel extension code associated with metadata determined to be restricted is not allowed to be loaded and/or is unloaded. Examples of metadata contents that may be specified to be restricted may be based on program types, kernel locations, attach functions, security IDs, etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method (CIM), the CIM comprising:
receiving, at a kernel space of a data processing system, from a user space, a policy, a kernel extension code, and metadata associated with the kernel extension code, wherein the metadata describes at least one type of attachment point in the kernel space, wherein the policy includes an allowlist and a blocklist of metadata for the attachment points;
validating the metadata against the policy;
performing an integrity measurement on the kernel extension code; and
in response to a determination that the metadata is validated against the policy and the integrity measurement is verified, loading the kernel extension code in the kernel space.

2. The CIM of claim 1, comprising: performing a verification of a signature included in the kernel extension code; and in response to a determination that the signature is verified, loading the kernel extension code in the kernel space.

3. The CIM of claim 1, comprising: in response to a determination that the policy has been updated: validating the metadata against the updated policy, and reperforming the integrity measurement on the kernel extension code.

4. The CIM of claim 3, comprising: in response to a determination that the metadata is not validated against the updated policy and/or the integrity measurement is not verified subsequent to the policy being updated, unloading the kernel extension code in the kernel space.

5. The CIM of claim 3, wherein a predetermined type of trigger causes the update of the policy, wherein the predetermined type of trigger includes an occurrence of debugging or initiation of a boot phase.

6. The CIM of claim 1, wherein the metadata associated with the kernel extension code includes a plurality of different types of metadata, wherein validating the metadata against the policy includes iteratively verifying each of the types of metadata against the policy.

7. The CIM of claim 1, wherein the metadata is selected from the group consisting of: indication of an attachment type, indication of a program type, and program instructions.

8. The CIM of claim 1, wherein validating the metadata against the policy includes determining whether the metadata matches an entry of the blocklist of metadata: wherein entries of the blocklist detail restricted metadata attributes selected from the group consisting of: a kernel location, an attach function, and a security identity (ID).

9. The CIM of claim 1, comprising:
in response to a determination that the metadata is not validated against the policy and/or the integrity measurement is not verified, preventing loading of the kernel extension code in the kernel space.

10. A computer program product (CPP), the CPP comprising:
a set of one or more computer-readable storage media;
program instructions, collectively stored in the set of one or more storage media, for causing a processor set to perform the following computer operations:
receive, at a kernel space of a data processing system, from a user space, a policy, a kernel extension code, and metadata associated with the kernel extension code, wherein the metadata describes at least one type of attachment point in the kernel space, wherein the policy includes an allowlist and a blocklist of metadata for the attachment points;
validate the metadata against the policy;
perform an integrity measurement on the kernel extension code; and
in response to a determination that the metadata is validated against the policy and the integrity measurement is verified, load the kernel extension code in the kernel space.

11. The CPP of claim 10, the CPP comprising: program instructions, collectively stored in the set of one or more storage media, for causing the processor set to perform the following computer operations: perform a verification of a signature included in the kernel extension code; and in response to a determination that the signature is verified, load the kernel extension code in the kernel space.

12. The CPP of claim 10, the CPP comprising: program instructions, collectively stored in the set of one or more storage media, for causing the processor set to perform the following computer operations: in response to a determination that the policy has been updated: validate the metadata against the updated policy, and reperform the integrity measurement on the kernel extension code.

13. The CPP of claim 12, the CPP comprising: program instructions, collectively stored in the set of one or more storage media, for causing the processor set to perform the following computer operations: in response to a determination that the metadata is not validated against the updated policy and/or the integrity measurement is not verified subsequent to the policy being updated, unload the kernel extension code in the kernel space.

14. The CPP of claim 12, wherein a predetermined type of trigger causes the update of the policy, wherein the predetermined type of trigger includes an occurrence of debugging or initiation of a boot phase.

15. The CPP of claim 10, wherein the metadata associated with the kernel extension code includes a plurality of different types of metadata, wherein validating the metadata against the policy includes iteratively verifying each of the types of metadata against the policy.

16. The CPP of claim 10, wherein the metadata is selected from the group consisting of: indication of an attachment type, indication of a program type, and program instructions.

17. The CPP of claim 10, wherein validating the metadata against the policy includes determining whether the metadata matches an entry of the blocklist of metadata: wherein entries of the blocklist detail restricted metadata attributes selected from the group consisting of: a kernel location, an attach function, and a security identity (ID).

18. The CPP of claim 10, the CPP comprising: program instructions, collectively stored in the set of one or more storage media, for causing the processor set to perform the following computer operations: in response to a determination that the metadata is not validated against the policy and/or the integrity measurement is not verified, prevent loading of the kernel extension code in the kernel space.

19. A computer system (CS), the CS comprising:
a processor set;
a set of one or more computer-readable storage media;
program instructions, collectively stored in the set of one or more storage media, for causing the processor set to perform the following computer operations:
receive, at a kernel space of a data processing system, from a user space, a policy, a kernel extension code, and metadata associated with the kernel extension code, wherein the metadata describes at least one type of attachment point in the kernel space, wherein the policy includes an allowlist and a blocklist of metadata for the attachment points;
validate the metadata against the policy;
perform an integrity measurement on the kernel extension code; and
in response to a determination that the metadata is validated against the policy and the integrity measurement is verified, load the kernel extension code in the kernel space.

20. The CS of claim 19, the CS comprising: program instructions, collectively stored in the set of one or more storage media, for causing the processor set to perform the following computer operations: perform a verification of a signature included in the kernel extension code; and in response to a determination that the signature is verified, load the kernel extension code in the kernel space.
